(19) United States
(12) Patent Application Publication
(10) Pub. No.: US 2012/0015326 A1
(43) Pub. Date: Jan. 19, 2012

(54) DENTAL RESTORATION SYSTEM AND METHOD THEREOF

(76) Inventor: Chan Q. Wang, Beachwood, OH (US)

(21) Appl. No.: 13/138,726

(22) PCT Filed: Mar. 22, 2010
(86) PCT No.: PCT/US10/00837

§ 371 Date: Sep. 22, 2011

Related U.S. Application Data
(60) Provisional application No. 61/162,333, filed on Mar. 22, 2009.

(51) Int. Cl. A61C 13/01; A61C 5/08

(52) U.S. Cl. 433/199.1; 433/218

(57) ABSTRACT

The invention provides a dental restoration system comprising a crown base such as a dentin or an abutment and a shape determiner that surrounds and measures the shape of an apical part in the crown base. The invention also provides a method of dental restoration, which comprises measuring the shape of the crown base that is not surrounded by the shape determiner; determining the shape of the entire crown base; and preparing a crown to be secured on the crown base. The invention exhibits merits such as a much simpler procedure, less gum injury and bone recession, cost-effectiveness, and excellent compatibility with CAD/CAM system, among others.

### BACKGROUND OF THE INVENTION

This application claims priority based on the U.S. Provisional application 61/162,333 filed on Mar. 22, 2009, which is incorporated herein by reference in its entirety.

The present invention relates to a dental restoration system and method thereof. It finds particular application in conjunction with dental prostheses such as crown, and will be described with particular reference thereto. However, it is to be appreciated that the present invention is also amenable to other dental prostheses such as veneers and bridges.

For a tooth that is damaged or lost, a dentist will design a crown to be secured on the remaining dentin or on an implant, and restore the function of that tooth. In designing a dental crown, it is critically important that the crown can accurately fit the oral environment, particularly, to fit the spatial configuration of the gum area around the tooth, for the purpose of, in addition to an aesthetic appearance, the hygiene in the interfacial region between the gum, the crown and the dentin or abutment/implant. As known to a skilled doctor or dentist, it is difficult to make clean margin for the reasons that the gum bleeds after prep; the soft tissue pushes back and occupies the space between the gum and prepped tooth; the abutment shoulder is lower than the gum level and buried inside in the gum tissue. For example, after prep the tooth for a traditional crown, the dentist numbs the patient's tooth (alive or not) before he or she uses a thick cotton thread called retraction cord to push away the gum and to stop the gum bleeding, so to acquire a clear impression. Usually, the dentist will soak the retraction cord in a hemostat liquid if the gum bleeds seriously. The procedure will take about 10 to 15 minutes to prepare the retraction cord and then pack it inside the gum. However, this time-consuming and labor-intensive procedure still can't guarantee a clear margin for the crown, because the gum will push back and resume more or less to its original condition, after the retraction cord is removed.

For a traditional implant crown, the retraction cord cannot be packed between the gum and implant, because the operation would separate the gum attached to the implant, and destroy the connection between the periodontal tissue and implant, which may cause the bone recession later. If serious, the operation may lead to the failure of the implantation. As such, dentists generally use an open tray, a close tray, or an OS-Tray to transfer the soft tissue or hard tissue impression to the stone model.

Disadvantageously, the procedure is complicated and needs to use a lot of small accessories. For implant methods, dentists have to transfer the soft tissue impression by using the impression copings and implant analogs to the lab, and a lab technician will pick up the abutment for them and modify it in the lab, then send back for the patient to try. This procedure eliminates the doctor's role in making the implant crown directly by working in the patient's mouth, reduces the accuracy of the operation, increases the lab fee and accessory expenses, burdens the patient with more office visits, and demands a lot more steps for the doctor to bring back the abutment to the right position.

U.S. Pat. No. 4,424,034 issued to Korwin et al. has disclosed a device for use in taking dental impressions. According to Korwin, a cylinder-like adjustment member having a plurality of adjustable elements is mounted in a tooth-encircling relationship with a prepared tooth having a finish line. Each element is adjustably movable so that its leading edges may be moved toward an attachment line defined by the neck of the tooth and its immediately adjacent gingival tissue below the visible gum line. The leading edges, after adjustment, define an impression line whose contour resembles the contour of the finish and/or attachment lines. The adjustment member may also be mounted on the prepared tooth to assist in the formation of a temporary crown, and may further be mounted as a readily removable matrix on a tooth requiring filling. However, the procedure of Korwin involves the management of a big number of the adjustable elements, and is still complicated, expensive, and labor intensive for a dentist.

Currently, the use of CAD/CAM in dentistry makes the traditional crown procedure much easier than before. An image sensor is used to take the image of the prepared tooth, and the crown will be made right away in the doctor's office. Alternatively, the image is sent to a lab through internet such as by e-mail, where the crown will be made and then sent back to the doctor's office. There is no impression step involved in the procedure. The CAD/CAM can't be used to make a crown on implant, because (i) currently there is no direct abutment set up in the patient's mouth; (ii) the direct modification of an implant abutment is currently not available; and (iii) the part of the abutment which is covered by the gum cannot be detected by the CAM/CAD sensor. As such, dentists set up the impression copings on the implant, and take impression of the implant and surrounding soft tissue. Subsequently, the lab technician builds up the stone model, and uses this model to make the abutment and the crown.

Advantageously, the present invention provides a dental restoration system and method thereof, which overcomes the aforementioned problems associated with the prior art, and exhibits numerous technical merits such as a clearer and easer impression; simplified operation such as elimination the step of packing a retraction cord; less injury such as bleeding to the gum and avoidance of the bone recession; a doctor's better control over the making of a crown; cost-effectiveness in terms of doctor chair time and lab cost; less usage of accessories; and fewer patient visits, among others. For example, one or more of these merits will be particularly exhibited when the present invention is combined with the modifiable abutment as disclosed in the co-pending patent application with Ser. No. 12/255,471 filed by the same applicant. The combination will enable a dentist to directly modify the abutment in a patient's mouth, and use the present invention with a CAD/CAM system.

### BRIEF DESCRIPTION OF THE INVENTION

One aspect of the invention provides a dental restoration system comprising:
(i) a crown base; and
(ii) a shape determiner, wherein the shape determiner directly surrounds a part of the crown base and conforms to the shape of the crown base surrounded by it.

In various embodiments, the dental restoration system may further comprise a means of measuring the shape of the crown base part that is not surrounded by the shape determiner. It may further comprises a means of determining the shape of the entire crown base based on the shape determiner and the measured shape of the crown base part that is not surrounded by the shape determiner. In embodiments, the dental restoration system further comprises a means of preparing a crown to be secured on the crown base, wherein the internal shape of the crown conforms to the shape of a part or the entirety of the crown base.

Another aspect of the invention provides a method of dental restoration, which comprises:
(i) providing a crown base;
(ii) directly surrounding the crown base with a shape determiner, wherein the shape determiner conforms to the shape of the crown base surrounded by the shape determiner;
(iii) measuring the shape of the crown base that is not surrounded by the shape determiner;
(iv) determining the shape of the entire crown base based on the shape determiner and the measured result from step (iii); and
(v) preparing a crown to be secured on the crown base, wherein the internal shape of the crown conforms to the shape of a part or the entirety of the crown base.

### BRIEF DESCRIPTION OF THE DRAWINGS

FIG. 1 is an illustration of the dental restoration system according to one embodiment of the invention;

FIG. 2 shows a shape determiner with grooves filled with a curable material according to an embodiment of the invention; and

FIG. 3 schematically illustrates a process of attaching a shape determiner to an impression material, both of which can jointly determining the shape of the entire crown base, according to an embodiment of the invention.

### DETAILED DESCRIPTION OF THE INVENTION

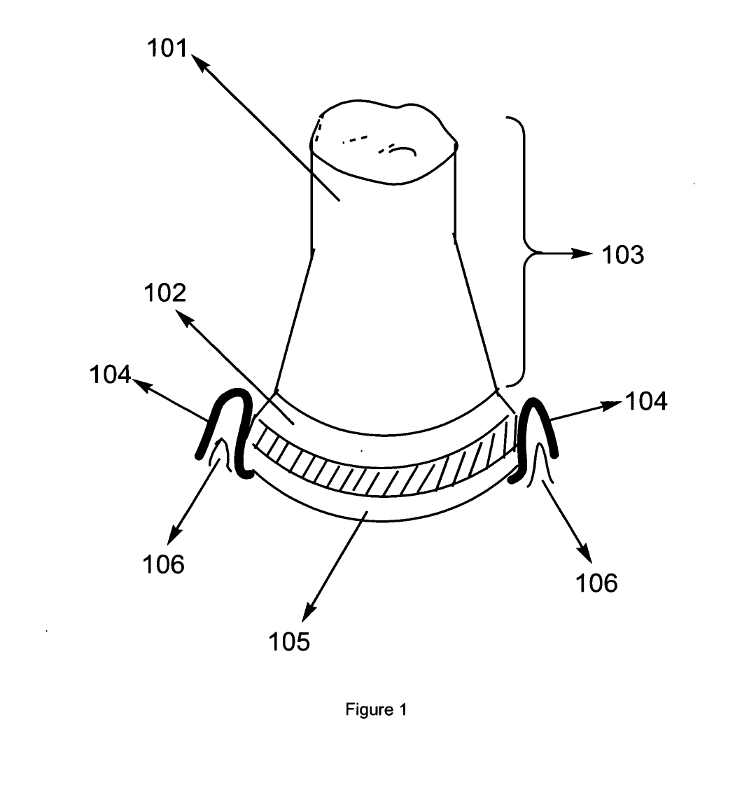

With reference to FIG. 1, the dental restoration system comprises a crown base 101 and a shape determiner 102. In preferred embodiments, the shape determiner of the invention may be a single piece with homogenous texture made of any suitable material such as metal, alloy, polymer, and composite material. The shape determiner 102 may be a regular or irregular ring directly surrounding the apical (bottom) part of the crown base 101. It may also be a regular or irregular C-shaped structure incompletely surrounding the crown base 101. In the interface between 101 and 102, the determiner 102 conforms to, or intimately contacts with, the shape (surface contour) of the bottom part of the crown base as surrounded by 102. In other words, the internal shape of the determiner 102 carries the accurate information of the internal shape of the corresponding portion of the crown to be made. Preferably, the external shape of the determiner 102 may also determine a corresponding portion of the external shape of the crown. In that case, the shape determiner 102 becomes an exact replica of the root portion or marginal portion of the crown.

A dentist may use any known methods to measure the shape of the crown base part 103 (i.e. the coronal part that is not surrounded by the shape determiner 102), and thus determine the information of the internal shape portion corresponding to 103 in the crown to be made. With the shape determiner 102 and the measured shape of the crown base part 103, a dentist can determine the external shape of the entire crown base 101, or the internal shape of the entire crown. With the external shape of the shape determiner 102, the dentist and lab technician also can determine the external shape of the crown part which is covered or partially covered by gum. The dentist can then prepare a crown (not shown) to be perfectly secured on the entire crown base 101, and he can also prepare a veneer (not shown) to be perfectly secured on a desired part of the crown base 101. The dental crown of the invention may be selected from, for example, an implant crown, a regular crown, a bridge, and a Cerac Crown.

In some embodiments as shown in FIG. 1, a part of the crown base is optionally surrounded by a free gingival margin or gum 104, inside of which are bones 106. In that case, at least a portion of the shape determiner 102 occupies at least a portion of the space between the crown base 101 and the free gingival margin 104. For example, the portion of the shape determiner that occupies the in-between space may have a volume of at least 30%, preferably at least 60%, and more preferably at least 90%, of the total volume of the shape determiner: In an embodiment, the entire shape determiner 102 is “buried” into the space between the crown base 101 and the free gingival margin 104. It is understood that, in other embodiments, a part of the shape determiner 102 may be present above the free gingival margin 104.

The crown base 101 may be, for example, the dentin of a tooth under restoration, or an abutment with or without the portion of an implant that is on or above the surface of the jawbone where the implant sits. A common abutment is substantially cylindrical that is typically screwed into the endosseous implant, on top of which the crown can be affixed. In preferred embodiments, the crown base 101 may be a part of the modifiable abutment as described in the co-pending patent application with Ser. No. 12/255,471 filed by the same applicant, which is incorporated herein in its entirety.

In various embodiments, the crown base 101 may optionally comprise a determiner stopper 105 (as shown in FIG. 1) that protects the nearby epithelial attachment against the pressure from the shape determiner 102. Any form of the determiner stopper may be used, for example, one or more protrusions on the crown base 101, a regular or irregular circular shoulder on the crown base 101.

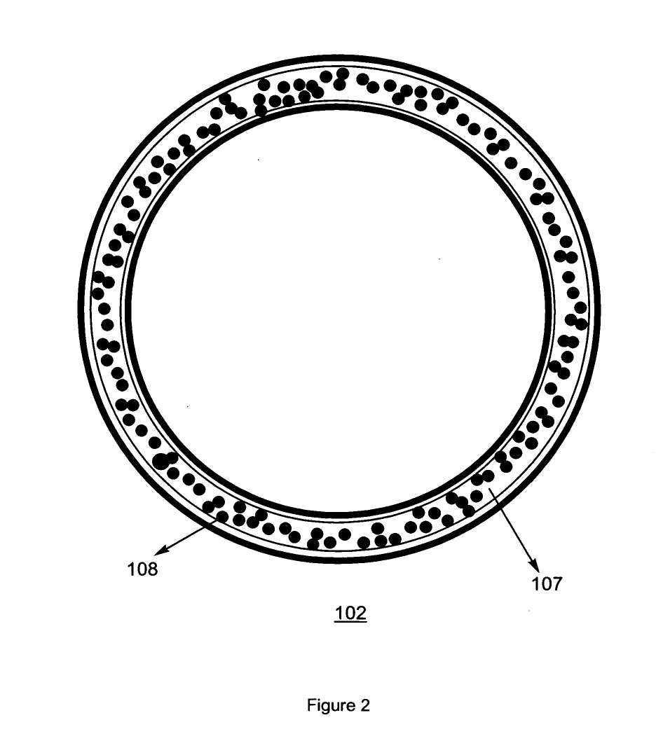

An exemplary embodiment of the shape determiner is shown in FIG. 2. With reference to FIG. 2, the shape determiner 102 may optionally comprise grooves 107 at its bottom (facing the stopper) fully filled with a material 108 that can be cured into a shape conforming to the contour of the determiner stopper 105. The term “cured” should be understood as hardened or solidified by, for example, chemical crosslinking, radiation or light induced polymerization or crosslinking, heating to remove solvent, heating to cause polymerization, and the like.

In preferred embodiments, the shape determiner 102 comprises a therapeutic and/or preventive medical agent such as a releasable hemostat agent for stopping the bleeding, for example, thrombin protein, kinases, chemicals, and vitamins. The surface of the shape determiner 102 may be loaded with the medical agent by way of for example, roughened surface or absorption with gauze, sponge, pledget, collagen, and poly-fibers. One of such shape determiners may be commonly named as, for example, a hemostat margin ring, which combines the function of hemostat cap and retraction cord.

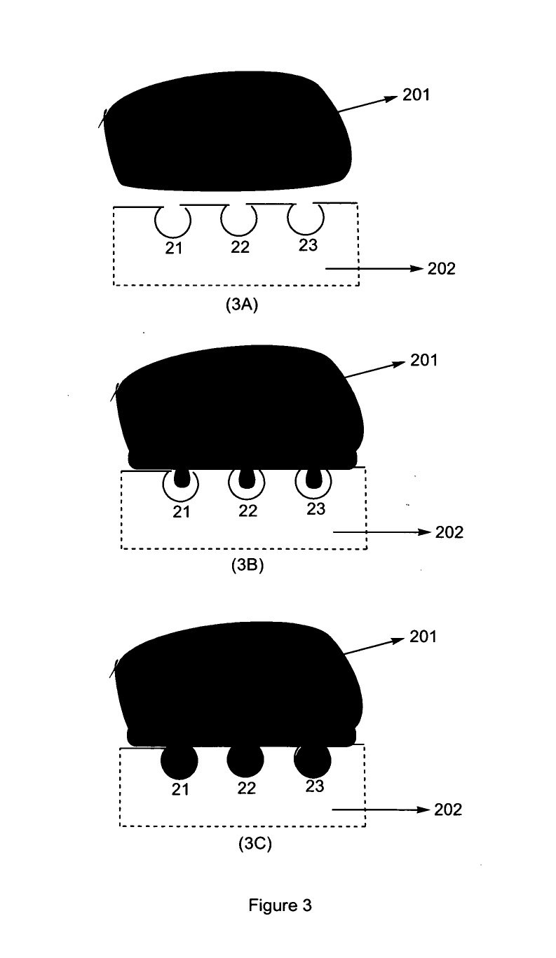

To measure the shape of the crown base part 103, a dentist can use any known impression material, and preferably, design a shape determiner 102 that is attachable to the impression material during the measurement. FIG. 3 schematically illustrates a process of attaching a shape determiner 202 to an impression material 201, and removing both the determiner 202 and the hardened/cured impression material 201 from the crown base (not shown in FIG. 3). With reference to FIG. 3A the shape determiner 202 may comprise one or more housing structures 21, 22, and 23 intended to accept the impression material 201. A dentist may press the material 201 so that it contacts the upper surface of 202, and the material 201 is forced to flow into 21, 22, and 23 FIGS. 3A and 3B). After the impression material 201, including those flowed into the housing structures 21, 22 and 23, is cured or hardened, the shape determiner can be attached to the impression material 201, and be removed with 201 from the crown base. By the same token, a shape determiner such as a hemostat margin ring may be designed to have pin holders on the upper surface, and integrated with an impression material when hardened.

For example, a negative impression mold may be made of the crown base. Such impression is typically made by positioning within the mouth of a patient a shallow curved tray which contains a polymer material such as alginate, elastomer, hydrocolloid or a polyether, which is capable of being indented by the crown base, and forming and retaining a stable impression of the crown base. The impression material is initially in the form of a putty, slurry or thick paste which rapidly solidifies at ambient room temperature and pressure. The tray is inserted into a patient's mouth positioned generally horizontally, and the patient bites down on the tray, or the tray is pressed into contact with the crown base, thus pressing the crown base into the viscous semi-liquid mold impression material held by the tray. After a few minutes, the mold impression material solidifies into a rubber-like elastomeric state which has formed therein precise negative impressions of the crown base.

Dental impression trays for use as described above are available in a variety of styles. One type tray has an accurately curved plan-view shape which is similar to the curved arrangement of teeth in the jaw. The curved arc length of the tray approximates that of about one half an upper or lower jaw and hence is referred to as a quadrant tray. A flat, paddle-like handle protruding horizontally outwards from one end of the tray is usually provided, to facilitate inserting and removing the tray from a patient's mouth. A typical quadrant tray has on one side thereof a curved trough for receiving impression mold material, may be used to make impressions of upper or lower jaw quadrants and is referred to as a standard quadrant or single-bite tray. A double side quadrant tray has been filled the impression material in both sides. When a patient gently bites down, the tray receives the impression of the crown base part 103 and 102. It also receives the bite information from the opposite occlusion which will help the doctor and lab technician to measure the external shape of the crown.

After impressions of teeth have been made in the manner described above, and the mold impression material solidified, the tray holding solidified mold impression material containing negative impressions of the crown base is removed. The mold, typically referred to as an “impression,” is then used to make positive replicas of the crown base by pouring a semi-liquid molding material such as plaster, or die stone, into the depressions formed in the impression, which are accurate negative replicas of the crown base. After the die stone has solidified into a hard stone-like casting, or cast, the cast is removed from the impression, a task which is facilitated by the fact that the impression material is elastomeric, enabling it to be readily peeled away from the die. The casting is then used to fabricate the targeted crown to be secured on the crown base.

To measure the shape of the crown base part 103, a dentist can also use any known imaging systems, such as a digital scanning system. For example, a scanner may be positioned proximate to the crown base, so that the distance between the scanner and the crown base is within the depth of focus of the optics of the scanner. A scanning system may capture a series of two-dimensional images containing surface information of the crown base, and then generate an accurate three-dimensional computer model of the crown base from the captured images. The surface configuration of the crown base in three dimensions of space can be represented as a mathematical model, i.e., a virtual model, which can be displayed on any workstation or computer using available software tools. The mathematical model can be viewed in any orientation in space, permitting detailed analysis of the surface. The virtual model can be transported from one computer and another computer anywhere in the world essentially instantaneously over communications links such as the Internet. The model can be replicated in a computer and thus shared and used by multiple users simultaneously.

The scanning system further includes at least one memory and one data processing unit, e.g., the central processing unit of a computer or a digital signal processor, which processes the images. Multiple processing units can be used to reduce the amount of time it takes to process the two-dimensional images, calculate three-dimensional coordinates for points in each image, and register frames of three-dimensional coordinates relative to each other to generate a complete virtual model. The processing unit and the memory can be located at a separate location, or be constructed in a single unit. A suitable cable may be used to connect the scanner device to a workstation to thereby supply the processing unit with scan data, and to receive commands (illumination commands, start/stop commands, etc.) from the workstation.

U.S. Pat. Nos. 4,837,732 and 4,575,805 have disclosed a scanning system for in vivo, non-contact scanning of teeth. The patents may be used to measure the shape of the crown base part 103, and are incorporated herein as references. The patents describe a procedure for optically mapping a prepared tooth with a non-contact scan-head. The scan-head delivers the contour data, converted to electrical format, to be stored in a memory. A computer reads the memory following a line scan pattern. The scan-head includes a light emitting diode, with integral lens that radiates light onto the cavity. Before reaching the object, the rays of light are reflected by a mirror and pass through a ruling consisting of a plurality of parallel slits, or an alternating pattern of parallel opaque and transparent stripes. The reflected light is focused by a lens onto a charge-coupled device (CCD) sensor. Basically, the object is viewed under an angle different from the incident rays due to a parallax effect. Each light stripe will have an apparent positional shift and the amount of the shift at each point along each light stripe is proportional to the vertical height of the corresponding portion of the surface on the object. Other patents may also be used to measure the shape of the crown base part 103, and are incorporated herein as references. For example, U.S. Pat. No. 5,372,502 teaches an optical probe for measuring teeth that works on a similar principle. U.S. Pat. No. 5,027,281 describes a scanning method using a three axis positioning head with a laser source and detector, a rotational stage and a computer controller. The computer controller positions both the rotational stage and the positioning head. An object is placed on the rotational stage and the laser beam reflects from it. The reflected laser beam is used to measure the distance between the object and the laser source. X and Y coordinates are obtained by movement of the rotational stage or the positioning head. A three-dimensional virtual model of the object is created from the laser scanning. U.S. Pat. No. 5,431,562 describes a method of acquiring certain shape information of teeth from a plaster model of the teeth. The plaster model is placed on a table and a picture is taken of the teeth using a video camera positioned a known distance away from the model, looking directly down on the model. The image is displayed on an input computer and a positioning grid is placed over the image of the teeth. The operator manually inputs X and Y coordinate information of selected points on the teeth, such as the mesial and distal contact points of the teeth. An alternative embodiment is described in which a laser directs a laser beam onto a model of the teeth and the reflected beam is detected by a sensor.

The material used to make to a crown in the invention is preferably inert and non-toxic in an oral environment. The crown should have chemical durability in an oral environment, sufficient structural integrity to resist the forces of mastication, wear characteristics which are similar to natural human teeth, and have esthetic qualities, such as coloration similar to human teeth with a slightly translucent appearance.

The crown may comprise any material selected from porcelain, metal, metal alloy, ceramic material, glass-ceramic material, polymeric material, and any combination thereof. In a preferred embodiment of the present invention, the ceramic material for the crown is a translucent polycrystalline material, because the natural tooth enamel has a high translucency, whereas dentine has a lower translucency. A polycrystalline material has a multiplicity of randomly oriented crystals joined at grain boundaries. Preferably, the ceramic material is substantially nonporous to maintain a high degree of optical translucency. Translucency is the property of a specimen by which it transmits light diffusely without permitting a clear view of objects beyond the specimen and not in contact with it. A translucent material is an advantage because a crown, for example, formed from such a material effectively blends in with its surroundings and assumes the color of the underlying tooth and the teeth adjacent to it. This can provide improved aesthetics as compared to more opaque materials. In some embodiments, a dentist may need to color-match a crown with the color and shade of the dentition that surrounds the crown. In an embodiment, the ceramic material for the crown is an alpha aluminum oxide. Aluminum oxide is particularly desirable since its optical transmittance is substantially constant throughout the visible spectrum and it therefore does not change the color of light passing through.

Steps (iii), (iv), and (v) in the method of the invention may be accomplished using a CAD/CAM system equipped with machines sold under the tradenames Sirona CEREC 2, Sirona CERAC 3, Dentronics DECIM or CadCam Ventures PROCAM a Cerac machine. For example, the material for making a crown may be a mill blank, which is hardened prior to changing its topography. Changing the topography can be accomplished to create custom-fit dental prosthesis having a desired shape in various ways including, carving or manual manipulation using hand held instruments, or by machine or computer aided apparatus (e.g., a CAD/CAM milling machine) for prostheses and mill blanks. By using a CAD/CAM milling device, a crown can be fabricated efficiently and with precision.

During the milling, the contact area may be dry, or it may be flushed with or immersed in a lubricant. Alternatively, it may be flushed with an air or gas stream. Suitable liquid lubricants are well known, and include water, oils, glycerine, ethylene glycols, and silicones. After milling, some degree of finishing, polishing, coating and adjustment may be necessary to obtain a custom fit into the mouth and/or aesthetic appearance. In a specific embodiment, the invention employs porcelain color spectrum (popular A-D shades such as A1-5, B1-5, C1-5) to determine the color of the crown.

In the present invention, a final crown product can be affixed to the crown base 101 as shown in FIG. 1 with a wide variety of bonding agents. Examples include composites, glass ionomer cements, resin cements, zinc phosphate, zinc polycarboxylate, copolymer, and resin-modified glass ionomer cements.

In an embodiment according to the invention, after putting on the impression coping or abutment (traditional way of implant restoration) or directly modified the pre-contoured abutment (e.g. the modifiable abutment in co-pending patent application with Ser. No. 12/255,471), a doctor can place the hemostat margin ring on the shoulder of the abutment, and the margin ring will gently push the gingival away. The rough surface with hemostat agent of margin ring will stop the bleeding of the gum, and clean up the area around the margin ring. After taking the impression, the margin ring will carry the soft tissue condition and the information of the determiner stopper on which the crown will sits, into a lab. The process does not need to bring all impression coping, accessories and abutment to the lab. For modifiable abutment system, dentists may put the pre-contoured permanent abutment directly on the restoration implant and adjust the abutment to fit the oral environment of the patient. He may then place the margin ring, directly take the impression, and send to the lab to get the crown. The dentist does not need the temporary abutment, the impression copies, and any other accessories. The procedure eliminates all the steps to mark the position to bring back the abutment and crown later.

Advantageously, a doctor may place the hemostat margin ring on the prepped tooth, then take impression right way. The doctor takes impression with the margin ring attached to it, and the margin ring is sent to a lab with the impression. This method obtains all the information of prepped tooth, abutment, and the surrounding soft tissue, and guarantees a clearer margin and better crowns. This procedure just takes seconds, and no special skill is needed. Moreover, this procedure lessens the injury of the gum, and alleviates the soreness of the gum.

In another embodiment according to the invention, a dentist using Cerac machine or CAD/CAM needs to send out their implant crown to the dental lab by taking impression. With margin ring and modifiable abutment in the co-pending patent application with Ser. No. 12/255,471, the dentist with Cerac machine can just make the crown like the regular crown. With the margin ring, dentists can use Cerac machine and CAD/CAM to make the crown directly. For example, a doctor may directly modify the pre-contoured abutment, and then place the hemostat margin ring on the shoulder of the abutment. The margin ring will gently push gingival away, and the rough surface with hemostat agent will stop the bleeding of the gum and clean up the area around the margin ring. The doctor may then use a laser explorer around the abutment, and the image will import to a computer. The doctor can make the crown with Cerac machine based on the image. He may also export the image to a dental lab, and the lab makes the crown without impression. when a doctor design the crown, he may add the volume of the margin ring which can't be detected by CAD/CAM sensor or explorer, because the part which margin ring replaced is covered or partially covered by gum, for example, by using a built-in computer program. A full and clear margin crown can be produced, and be put on the patient in one visit.

In a clinical situation, if the prepped shoulder is not smooth or doesn't match the standard margin ring exactly, then doctor can choose to use a flexible margin ring. In this embodiment, the bottom side (shoulder side) of the flexible margin rings may be designed to have one or more depressed hallow grooves. A doctor may fill the groove with composite, place the ring on the unsmooth shoulder of the prepped tooth, press gently, clean up the area around, and then cure the composite with for example a UV light source (light cure), or cure the composite chemically.

In a specific embodiment, the invention may combine with the co-pending patent application with Ser. No. 12/255,471, and provide a simplified procedure as the following: pick up an OsteoSecure abutment (commercially available from OsteoSecure Inc. at Beachwood, Ohio) with the color which match the patient other tooth; place the OsteoSecure abutment (with a shape determiner) on the implant, and secure with fix screw; shape the abutment to fit the occlusion relation; take impression (with attached shape determiner) and send to the lab; and lab technician makes the crown and send back to dentist.

In a specific embodiment, the invention may combine with the co-pending patent application with Ser. No. 12/255,471, and provide a method for making Cerac crown as the following: pick up an OsteoSecure abutment (commercially available from OsteoSecure Inc. at Beachwood, Ohio) with the color which can match the patient other tooth; place the OsteoSecure abutment (with a shape determiner) on the implant, and secure with fix screw; shape the abutment to fit the occlusion relation; use Cerac machine to make a crown (after adding the volume of the shape determiner); and dentist put the crown on top of the abutment. An advantage of this embodiment is the direct connection with CERAC machine to make the crown without impression.

The exemplary embodiments have been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

1. A method of dental restoration, which comprises:
(i) providing a crown base;
(ii) directly surrounding the crown base with a shape determiner, wherein the shape determiner conforms to the shape of the crown base surrounded by the shape determiner;
(iii) measuring the shape of the crown base that is not surrounded by the shape determiner;
(iv) determining the shape of the entire crown base based on the shape determiner and the measured result from step (iii); and
(v) preparing a crown to be secured on the crown base, wherein the internal shape of the crown conforms to the shape of a part or the entirety of the crown base.

2. The method according to claim 1, wherein step (iii) is performed using an impression material.

3. The method according to claim 2, wherein the impression material is attachable to the shape determiner.

4. The method according to claim 3, wherein the shape determiner comprises one or more housing structures for the impression material, and the shape determiner is attached to the impression material after the impression material in the housing structure(s) is hardened.

5. The method according to claim 1, wherein step (iii) is performed using an imaging system.

6. The method according to claim 5, wherein the imaging system comprises a CAD/CAM system.

7. The method according to claim 1, wherein step (v) is performed using a Cerac machine.

8. The method according to claim 1, further comprising a step of determining a portion of the external shape of the crown based on the external shape of the shape determiner.

9. A dental restoration system comprising (i) a crown base; and (ii) a shape determiner, wherein the shape determiner directly surrounds a part of the crown base and conforms to the shape of the crown base surrounded by it.

10. The dental restoration system according to claim 9, further comprising a means of measuring the shape of the crown base part that is not surrounded by the shape determiner.

11. The dental restoration system according to claim 10, further comprising a means of determining the shape of the entire crown base based on the shape determiner and the measured shape of the crown base part that is not surrounded by the shape determiner.

12. The dental restoration system according to claim 11, further comprising a means of preparing a crown to be secured on the crown base, wherein the internal shape of the crown conforms to the shape of a part or the entirety of the crown base.

13. The dental restoration system according to claim 12, wherein the shape determiner further determines a portion of the external shape of the crown.

14. The dental restoration system according to claim 9, wherein the shape determiner is a single piece with homogenous texture.

15. The dental restoration system according to claim 9, wherein a part of the crown base is surrounded by a free gingival margin; and at least a portion of the shape determiner occupies at least a portion of the space between the crown base and the free gingival margin.

16. The dental restoration system according to claim 15, wherein said at least a portion of the shape determiner has a volume of at least 30% of the total volume of the shape determiner.

17. The dental restoration system according to claim 9, wherein the crown base comprises the dentin of a tooth under restoration, a modifiable abutment, or an abutment with or without the portion of an implant that is on or above the surface of the jawbone where the implant sits.

18. The dental restoration system according to claim 9, wherein the crown base comprises a determiner stopper that protects the nearby epithelial attachment against the pressure from the shape determiner.

19. The dental restoration system according to claim 9, wherein the shape determiner is a regular or irregular ring surrounding the crown base.

20. The dental restoration system according to claim 9, wherein the shape determiner is a regular or irregular C-shaped structure incompletely surrounding the crown base.

21. The dental restoration system according to claim 9, wherein the shape determiner comprises a therapeutic and/or preventive medical agent such as a releasable agent.

22. The dental restoration system according to claim 9, wherein the shape determiner comprises a material at the bottom that can be cured into a shape conforming to the contour of the determiner stopper.
